(19) United States
(12) Patent Application Publication
(10) Pub. No.: US 2014/0063411 A1
(43) Pub. Date: Mar. 6, 2014

(54) LIQUID CRYSTAL DISPLAY DEVICE

(71) Applicant: Japan Display Inc., Tokyo (JP)

(72) Inventor: Satoshi TAKAHASHI, Isumi (JP)

(73) Assignee: JAPAN DISPLAY INC., Tokyo (JP)

(21) Appl. No.: 14/010,831

(22) Filed: Aug. 27, 2013

(30) Foreign Application Priority Data
Aug. 28, 2012 (JP) 2012-187223

(51) Int. Cl. G02F 1/1335

(52) U.S. Cl. CPC G02F 1/133603
USPC 349/61

(57) ABSTRACT

A liquid crystal display device includes a liquid crystal display panel, a backlight including at least one light-emitting diode, a booster circuit part which includes a smoothing capacitor made of a ceramic capacitor at an output end, boosts a power supply voltage and applies the boosted voltage to the at least one light-emitting diode, a constant current circuit to drive the at least one light-emitting diode at a constant current based on a PWM signal inputted from outside, and a ripple reducing circuit to reduce an electric potential change of the smoothing capacitor based on the PWM signal inputted from the outside.

### CROSS-REFERENCE TO RELATED APPLICATION

The present application claims priority from Japanese application JP2012-187223 filed on Aug. 28, 2012, the content of which is hereby incorporated by reference into this application.

### BACKGROUND OF THE INVENTION

1. Field of the Invention

The present invention relates to a liquid crystal display device, and particularly to a drive circuit of a white light-emitting diode constituting a light source of a backlight.

2. Description of the Related Art

A small liquid crystal display device of TFT (Thin Film Transistor) system using a thin film transistor (TFT) as an active element is widely used for a display part of a cellular phone or the like. The liquid crystal display device includes a liquid crystal display panel and a backlight to irradiate the liquid crystal display panel.

In the small liquid crystal display device, a white light-emitting diode is used as a light source of the backlight. In the liquid crystal display device using the white light-emitting diode as the light source of the backlight, an LED drive circuit to drive the white light-emitting diode drives the white light-emitting diode at a constant current with a voltage boosted by a booster circuit.

### SUMMARY OF THE INVENTION

In general, an LED drive circuit to drive a white light-emitting diode includes a booster circuit, and the booster circuit includes a smoothing capacitor.

Besides, in a liquid crystal display device using a white light-emitting diode as alight source of a backlight, in general, the duty ratio of on/off period of the white light-emitting diode is changed by PWM (Pulse Width Modulation) control and the brightness of the backlight is adjusted.

When the brightness of the backlight is adjusted by the PWM control, current flowing through the white light-emitting diode is changed to 0% or 100%. Thus, when a ceramic capacitor is used as the smoothing capacitor of the booster circuit in the LED drive circuit, voltages at both ends of the ceramic capacitor are changed, and there is a problem that the ceramic capacitor generates a sound noise.

In order to solve this problem, in the related art, an aluminum electrolytic capacitor or a functional polymer capacitor is used as the smoothing circuit of the booster circuit instead of the ceramic capacitor.

However, the aluminum electrolytic capacitor or the functional polymer capacitor has problems that (1) the life thereof is shorter than that of the ceramic capacitor, (2) the inner resistance is high, (3) the part shape is large and (4) the use temperature range is narrow.

The invention is made to solve the problems of the related art, and an object of the invention is to provide a technique to enable a ceramic capacitor to be used as a smoothing capacitor of a booster circuit of a backlight of a liquid crystal display device.

The foregoing and other objects of the invention and novel features thereof will be clarified by the description of the specification and the attached drawings.

The outline of typical ones of inventions disclosed in the present application will be briefly described below.

(1) A liquid crystal display device includes a liquid crystal display panel, a backlight including at least one light-emitting diode, a booster circuit part which boosts a power supply voltage and applies the boosted voltage to the at least one light-emitting diode, and a constant current circuit to drive the at least one light-emitting diode at a constant current based on a PWM signal inputted from outside, the booster circuit part includes a smoothing capacitor made of a ceramic capacitor at an output end, and a ripple reducing circuit to reduce an electric potential change of the smoothing capacitor based on the PWM signal inputted from the outside is provided.

(2) In (1), the booster circuit part includes a booster circuit, a coil, one end of which is connected to a power supply, a switching element which is connected between the other end of the coil and a ground potential and on/off of which is controlled by the booster circuit, and a diode connected to the other end of the coil, the smoothing capacitor is the ceramic capacitor and is connected to the diode, and the ripple reducing circuit generates a ripple voltage for reducing the electric potential change of the smoothing capacitor based on the PWM signal inputted from the outside, and inputs the ripple voltage to a feedback terminal of the booster circuit.

(3) In (2), the ripple reducing circuit includes a delay circuit which delays the PWM signal inputted from the outside and inputs the PWM signal to the constant current circuit, a phase adjustment circuit to invert the PWM signal inputted from the outside, an amplitude adjustment circuit to adjust an amplitude of a signal outputted from the phase adjustment circuit, and a capacitor to supply an output of the amplitude adjustment circuit to the feedback terminal of the booster circuit.

The effects obtained by the typical ones of the inventions disclosed in the present application will be briefly described below.

According to the invention, a ceramic capacitor which is inexpensive and small as compared with an aluminum electrolytic capacitor or the like can be used as a smoothing capacitor of a booster circuit of a backlight of a liquid crystal display device.

### BRIEF DESCRIPTION OF THE DRAWINGS

FIG. 1 is a block diagram showing a schematic structure of a liquid crystal display device of an embodiment of the invention.

FIG. 2 is a circuit diagram showing a circuit structure of an LED drive circuit of the liquid crystal display device of the embodiment of the invention.

FIG. 3 shows timing chart A to F of the LED drive circuit of the liquid crystal display device of the embodiment of the invention.

FIG. 4 is a circuit diagram showing a circuit structure of an LED drive circuit of a liquid crystal display device of related art.

FIG. 5 shows timing chart A to C of the LED drive circuit of the liquid crystal display device of the related art.

### DETAILED DESCRIPTION OF THE INVENTION

Hereinafter, an embodiment of the invention will be described in detail with reference to the drawings.

Incidentally, in all the drawings for explaining the embodiment, components having the same function are denoted by the same reference signs and repetitive explanation thereof will be omitted. Besides, the following embodiment is not intended to limit the interpretation of the claims of the invention.

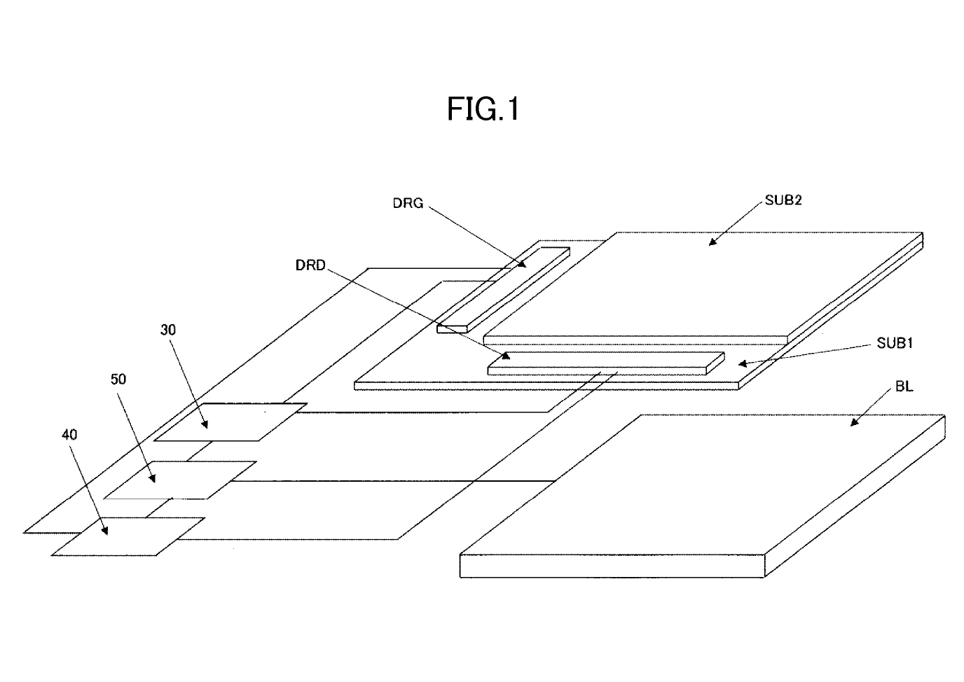

FIG. 1 is a block diagram showing a schematic structure of a liquid crystal display device of an embodiment of the invention.

The liquid crystal display device of the embodiment includes a liquid crystal display panel and a direct type backlight (BL). The liquid crystal display panel includes a first substrate (SUB1) and a second substrate (SUB2). A thin film transistor, a pixel electrode and the like are formed on the first substrate (SUB1). A light-shielding film, a color filter and the like are formed on the second substrate (SUB2). Incidentally, in the liquid crystal display panel of lateral electric field system such as an IPS system, an opposite electrode is formed on the first substrate (SUB1), while in the liquid crystal display panel of vertical electric field system such as a VA system, the opposite electrode is formed on the second substrate (SUB2).

The liquid crystal display panel is constructed such that the first substrate (SUB1) and the second substrate (SUB2) are boned to each other through a seal adhesive, and a liquid crystal is injected and sealed between the first substrate (SUB1) and the second substrate (SUB2). A polarizing plate (not shown) is provided on the outside of each of the first substrate (SUB1) and the second substrate (SUB2). Incidentally, since the invention does not directly relate to the structure of the liquid crystal display panel, the structure of the liquid crystal display panel is omitted.

A video line drive circuit (DRD) is disposed on a periphery of one of long sides of the first substrate (SUB1), and a scanning line drive circuit (DRG) is disposed on a periphery of one of short sides of the first substrate (SUB1).

The video line drive circuit (DRD) and the scanning line drive circuit (DRG) are controlled and driven by a display control circuit (timing controller) 30.

Incidentally, in FIG. 1, although the description is made on the case where each of the video line drive circuit (DRD) and the scanning line drive circuit (DRG) includes two semiconductor chips, each of the video line drive circuit (DRD) and the scanning line drive circuit (DRG) may include one semiconductor chip.

The backlight (BL) includes a white light-emitting diode (not shown) as a light source, and the white light-emitting diode is driven by an LED drive circuit 50. Besides, a control signal is inputted to the LED drive circuit 50 from the display control circuit 30.

A power supply circuit 40 supplies a voltage for driving each pixel to the video line drive circuit (DRD) and the scanning line drive circuit (DRG), and supplies an input voltage (Vin) to the LED drive circuit 50.

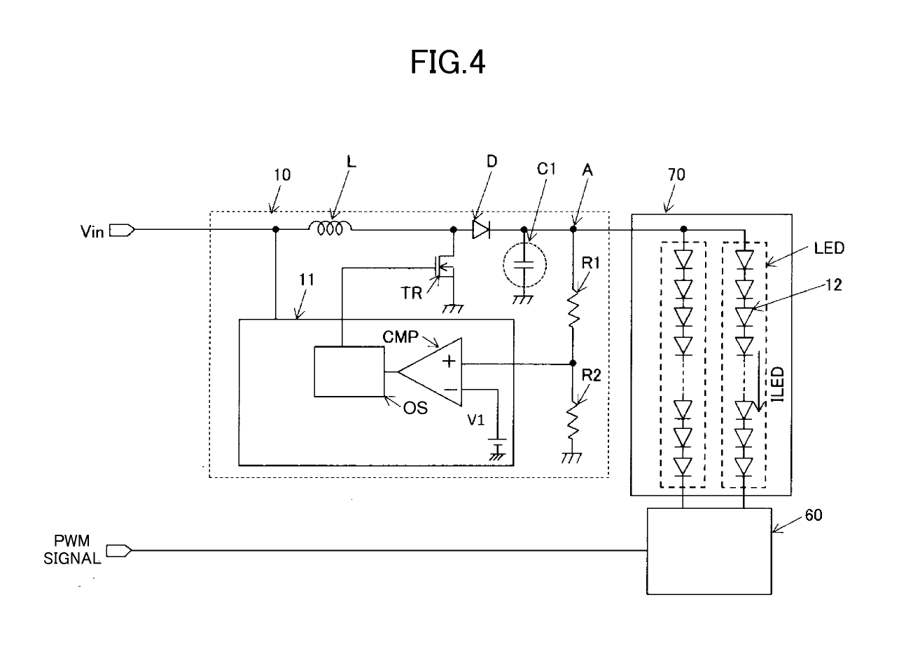

FIG. 4 is a circuit diagram showing a circuit structure of an LED drive circuit of a liquid crystal display device of related art. First, problems of the LED drive circuit of the related art will be described with reference to FIG. 4.

The LED drive circuit of the related art shown in FIG. 4 includes a booster circuit part 10, a constant current circuit 60 and a backlight part 70.

The booster circuit part 10 includes a coil (L), a diode (D), a smoothing capacitor (C1), an n-type MOS transistor (TR) constituting a switching element, and a booster circuit 11 to control on/off of the n-type MOS transistor (TR).

The booster circuit part 10 converts 12V voltage supplied from the power supply circuit 40 into a drive voltage (for example, 50V) suitable for driving plural white light-emitting diode lines (LED).

The booster circuit 11 includes a comparator (CMP) which compares a feedback voltage inputted to a feedback terminal (a voltage obtained by dividing an electric potential at point A of FIG. 4 by a resistive voltage divider circuit including a resistive element (R1) and a resistance element (R2)) with a reference voltage (reference voltage V1 of the inside of IC), and outputs a High level (hereinafter referred to as an H level) when the feedback voltage is lower than the reference voltage, and a pulse oscillator (OS) which outputs a pulse voltage when the output of the comparator (CMP) is at the H level.

Here, on/off of the n-type MOS transistor (TR) is controlled by the pulse voltage outputted from the oscillator (OS) of the booster circuit 11.

The backlight part 70 includes the plural white light-emitting diode lines (LED) in each of which plural white light-emitting diodes 12 are connected in series.

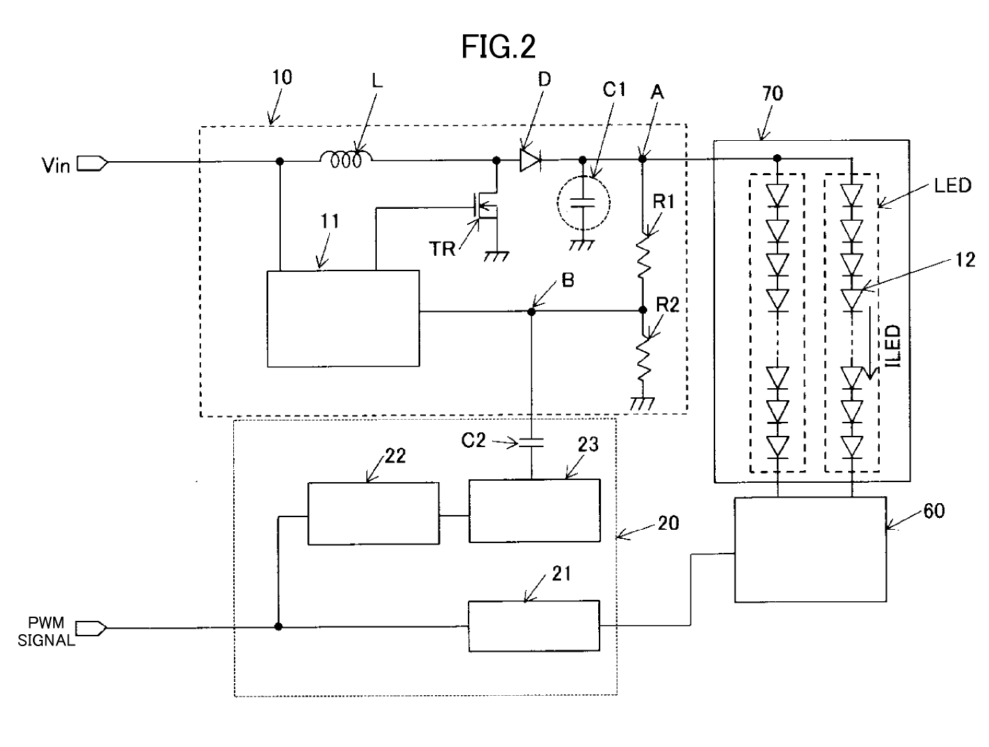

A PWM (Pulse Width Modulation) signal is inputted from the outside to the constant current circuit 60, and when the PWM signal is at the High level, and the constant current circuit 60 maintains the current flowing through the white light-emitting diode 12 of each of the plural white light-emitting diode lines (LED) at a constant current (constant current of ILED in FIG. 2).

Besides, when the PWM signal is at a Low level (hereinafter referred to as an L level), the current flowing through the plural white light-emitting diode lines (LED) becomes 0.

By this, the light-emitting time of the white light-emitting diode 12 of each of the plural white light-emitting diode lines (LED) is controlled, and the brightness of the backlight (BL) is adjusted (hereinafter referred to as PWM dimming).

The booster circuit part 10 controls the on/off of the n-type MOS transistor (TR) to convert the 12V voltage supplied from the power supply circuit 40 into the drive voltage (for example, 50V) suitable for driving the plural white light-emitting diode lines (LED), and controls the on/off of the n-type MOS transistor (TR) so that the current flowing through the white light-emitting diode 12 of each of the plural white light-emitting diode lines (LED) becomes the constant current.

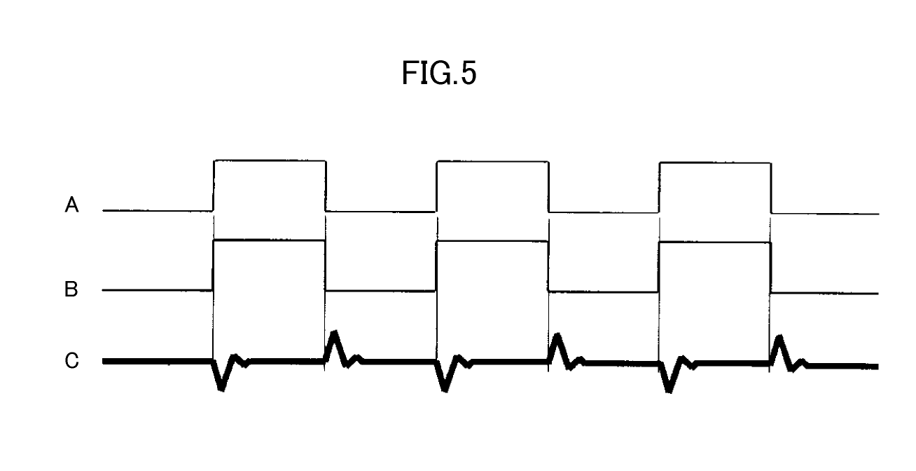

FIG. 5 shows timing chart A to C of the LED drive circuit of the liquid crystal display device of the related art.

As shown in the chart A of FIG. 5, when the brightness of the backlight (BL) is adjusted by the PWM signal, the current flowing through the white light-emitting diode 12 of each of the plural white light-emitting diode lines (LED) changes to 0% or 100% as shown in the chart B of FIG. 5.

When the current from 0% to 100% starts to flow through the plural white light-emitting diode lines (LED), since the current supply is insufficient, the electric potential at point A of FIG. 4 starts to decrease. Then, the booster circuit 11 detects the voltage reduction at point A by a feedback loop, and starts an operation of increasing the current supply to increase the electric potential at point A. Thus, a ripple voltage is generated as shown in the chart C of FIG. 5.

Besides, when the current flowing through the plural white light-emitting diode lines (LED) changes from 100% to 0%, the opposite operation occurs, and as shown in the chart C of FIG. 5, a ripple voltage is generated in which the electric potential at point A is once increased and is decreased.

That is, when the PWM dimming is performed, since the boosting operation of the booster circuit part 10 and the stop of the boosting operation are repeated, voltages at both ends of the smoothing capacitor (C1) are also changed.

When the ceramic capacitor is used as the smoothing capacitor (C1), there is a problem that the electric potential change causes the shape change of the ceramic capacitor, which generates a sound. Thus, the aluminum electrolytic capacitor or the functional polymer capacitor is used as the smoothing capacitor (C1) in the related art. As described before, when the aluminum electrolytic capacitor or the functional polymer capacitor is used as the smoothing capacitor (C1), there are problems that (1) the life is shorter than that of the ceramic capacitor, (2) the inner resistance is high, (3) the part shape is large and (4) the use temperature range is narrow.

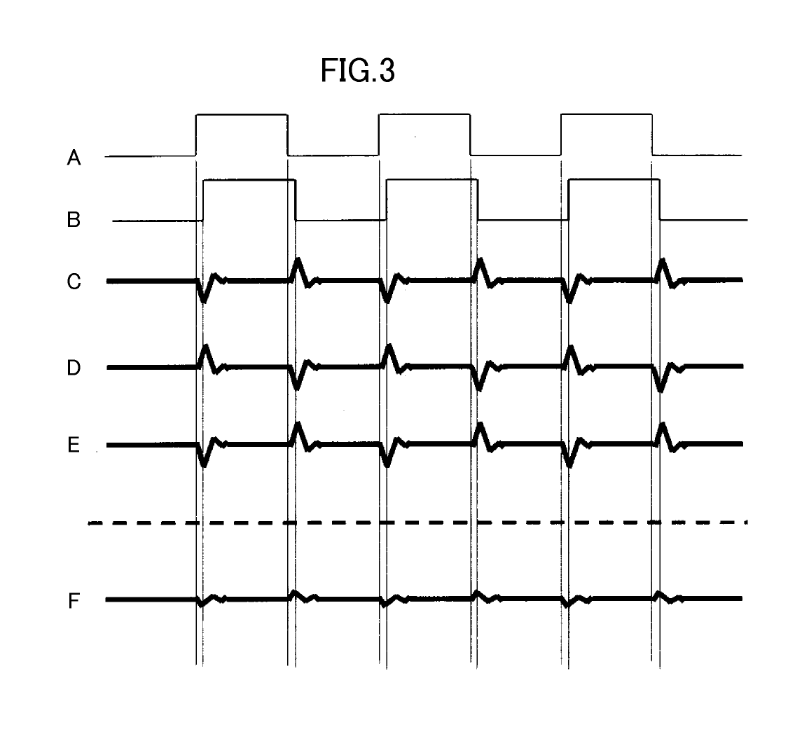

FIG. 2 is a circuit diagram showing a circuit structure of an LED drive circuit of the liquid crystal display device of the embodiment of the invention. FIG. 3 shows timing chart A to F of the LED drive circuit of the liquid crystal display device of the embodiment of the invention.

As shown in FIG. 2, the LED drive circuit of this embodiment is different from the LED drive circuit shown in FIG. 4 in that a ripple reducing circuit 20 is provided. Incidentally, in FIG. 2, illustration of an inner circuit of a booster circuit 11 is omitted.

The ripple reducing circuit 20 of the embodiment includes a delay circuit 21 which delays a PWM signal by, for example, 10 micro-seconds and inputs the signal to a constant current circuit 60, a phase adjustment circuit 22 to invert the PWM signal, an amplitude adjustment circuit 23 to adjust the amplitude of the signal outputted from the phase adjustment circuit 22, and a capacitor (C2) to input the output of the amplitude adjustment circuit 23 to a connection point (that is, a feedback terminal of the booster circuit 11) between a resistive element R1 and a resistive element R2.

In the ripple reducing circuit 20, the phase adjustment circuit 22 inverts the PWM signal, the amplitude adjustment circuit 23 adjust the amplitude of the signal outputted from the phase amplitude adjustment circuit 22, and the signal is inputted to the connection point between the resistive element R1 and the resistive element R2 via the capacitor (C2). By this, the voltage at point B of FIG. 2 is changed, and the voltage at point A is also changed in accordance with the change.

For example, when the PWM signal is changed from the L level to the H level, the voltage inputted from the amplitude adjustment circuit 23 via the capacitor (C2) to the connection point between the resistive element R1 and the resistive element R2 is the voltage for decreasing the electric potential at point B of FIG. 2 as shown in the chart C of FIG. 3. Thus, the booster circuit part 10 increases the electric potential at point A of FIG. 2 as shown in the chart D of FIG. 3.

In this embodiment, when the voltage at point A of FIG. 2 starts to change, the PWM signal is inputted to the constant current circuit 60 via the delay circuit 21 in order to change the current flowing through the plural white light-emitting diode lines (LED). By this, as shown in the chart B of FIG. 3, after a specified delay time elapses, the current flowing through the white light-emitting diode lines (LED) changes from 0% to 100% in accordance with the change of the PWM signal.

As described before, when the current from 0% to 100% starts to flow through the white light-emitting diode lines (LED), the current supply becomes insufficient, and the electric potential at point A starts to decrease. Then, the booster circuit 11 detects the voltage reduction at point A by the feedback loop, and starts the operation of increasing the current supply to increase the electric potential at point A. Accordingly, a ripple voltage is generated.

However, in this embodiment, even if the current from 0% to 100% starts to flow through the white light-emitting diode lines (LED), and the electric potential at point A starts to decrease, since the electric potential at point A is previously increased, the voltage change at point A is reduced as shown in the chart F of FIG. 3, and the ripple voltage can also be reduced.

Besides, when the PWM signal is changed from the H level to the L level, the voltage inputted from the amplitude adjustment circuit 23 via the capacitor (C2) to the connection point between the resistive element R1 and the resistive element R2 is the voltage for increasing the electric potential at point B of FIG. 2 as shown in the chart C of FIG. 3. Thus, the booster circuit part 10 decreases the electric potential at point A of FIG. 2 as shown in the chart D of FIG. 3.

Besides, as shown in the chart B of FIG. 3, after the specified delay time elapses, the current flowing through the white light-emitting diode line (LED) changes from 100% to 0% in accordance with the change of the PWM signal.

As described before, when the current flowing through the white light-emitting diode line (LED) changes from 100% to 0%, the ripple voltage is generated in which the electric potential at point A is once increased and is decreased.

However, in this embodiment, even if the current flowing through the white light-emitting diode line (LED) changes from 100% to 0%, and the electric potential at point A starts to increase, since the electric potential at point A is previously decreased, the voltage change at point A is reduced as shown in the chart F of FIG. 3, and the ripple voltage can also be reduced.

Incidentally, the chart E of FIG. 3 shows a voltage change at point A when there is no ripple reducing circuit 20 of the embodiment (in the case of the LED drive circuit of the related art).

As described above, in this embodiment, since the voltage (voltage at point A of FIG. 2) of the smoothing capacitor (C1) is stabilized by the ripple reducing circuit 20, even if the ceramic capacitor is used as the smoothing capacitor (C1) of the booster circuit part 10, the shape change of the ceramic capacitor disappears, and the sound generation disappears as well.

Besides, since the ceramic capacitor is inexpensive and small as compared with the aluminum electrolytic capacitor or the functional polymer capacitor, the whole LED drive circuit including the booster circuit can be made small, and the life can be prolonged.

Although the invention made by the inventor is specifically described based on the embodiment, the invention is not limited to the embodiment, but can be variously modified within the scope not departing from the gist thereof.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A liquid crystal display device comprising:
a liquid crystal display panel;
a backlight including at least one light-emitting diode;
a booster circuit part which includes a smoothing capacitor made of a ceramic capacitor at an output end, boosts a power supply voltage, and applies the boosted voltage to the at least one light-emitting diode;
a constant current circuit to drive the at least one light-emitting diode at a constant current based on a PWM signal inputted from outside; and
a ripple reducing circuit to reduce an electric potential change of the smoothing capacitor based on the PWM signal inputted from the outside.

2. The liquid crystal display device according to claim 1, wherein the booster circuit part includes
a booster circuit,
a coil, one end of which is connected to a power supply,
a switching element which is connected between the other end of the coil and a ground potential and on/off of which is controlled by the booster circuit, and
a diode connected to the other end of the coil, wherein
the smoothing capacitor is the ceramic capacitor and is connected to the diode, and
the ripple reducing circuit generates a ripple voltage for reducing the electric potential change of the smoothing capacitor based on the PWM signal inputted from the outside, and inputs the ripple voltage to a feedback terminal of the booster circuit.

3. The liquid crystal display device according to claim 2, wherein the ripple reducing circuit includes
a delay circuit which delays the PWM signal inputted from the outside and inputs the PWM signal to the constant current circuit,
a phase adjustment circuit to invert the PWM signal inputted from the outside,
an amplitude adjustment circuit to adjust an amplitude of a signal outputted from the phase adjustment circuit, and
a capacitor to supply an output of the amplitude adjustment circuit to the feedback terminal of the booster circuit.
